(19) United States
(12) Patent Application Publication
(10) Pub. No.: US 2015/0170273 A1
(43) Pub. Date: Jun. 18, 2015

(54) PRICE BANDING VISUALIZATION

(71) Applicant: Chicago Mercantile Exchange Inc., Chicago, IL (US)

(72) Inventors: James David Russell Barry, Chicago, IL (US); Peter Nunn, Chicago, IL (US); Russell Robertson, Chicago, IL (US)

(73) Assignee: Chicago Mercantile Exchange Inc., Chicago, IL (US)

(21) Appl. No.: 14/132,408

(22) Filed: Dec. 18, 2013

(51) Int. Cl. G06Q 40/04

(52) U.S. Cl. CPC G06Q 40/04

(57) ABSTRACT

A computer-implemented method facilitates an order by a market participant for a trade of a financial instrument via an exchange computer system. The method includes determining a price band for valid orders of the financial instrument, generating an order entry interface configured for entry of data by the market participant indicative of the order of the financial instrument, the order entry interface including a visual indication of the price band, capturing data indicative of the order entered via the order entry interface, and transmitting the captured data to the exchange computer system.

### BACKGROUND

A financial instrument trading system, such as a futures exchange, referred to herein also as an “Exchange”, such as the Chicago Mercantile Exchange Inc. (CME), provides a contract market where financial instruments, for example futures and options on futures, are traded. Futures is a term used to designate all contracts for the purchase or sale of financial instruments or physical commodities for future delivery or cash settlement on a commodity futures exchange. A futures contract is a legally binding agreement to buy or sell a commodity at a specified price at a predetermined future time. An option is the right, but not the obligation, to sell or buy the underlying instrument (in this case, a futures contract) at a specified price within a specified time. The commodity to be delivered in fulfillment of the contract, or alternatively the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement.

Typically, the Exchange provides a centralized “clearing house” through which all trades made must be confirmed, matched, and settled each day until offset or delivered. The clearing house is an adjunct to the Exchange, and may be an operating division of the Exchange, which is responsible for settling trading accounts, clearing trades, collecting and maintaining performance bond funds, regulating delivery, and reporting trading data.

The Exchange also provides a trading platform for electronic trading. For example, the Chicago Mercantile Exchange operates the CME Globex electronic trading platform for trading of futures, options, and other derivative financial instruments. The electronic trading platform is supported by a computer system maintained by the Exchange. Market participants remotely access the computer system of the Exchange to place an order for a trade of a financial instrument. Each market participant uses a computing system or device configured to present a trading interface, such as an order entry ticket interface. Order information entered by the market participant is sent to the Exchange for processing.

The widespread use of electronic trading has led to the adoption of safeguards to protect the integrity of the financial markets. One safeguard instituted by Exchanges imposes a price band on orders. Orders specifying a price outside of the price band are rejected as invalid. Price banding is thus used to protect markets from distortions that would otherwise arise from erroneous orders. Orders may be erroneous, for instance, as a result of a data entry error by the trader using the trading interface. Such data entry errors are often referred to as “fat finger” events.

### BRIEF DESCRIPTION OF THE DRAWINGS

FIG. 1 depicts an illustrative computer network system that may be used to implement electronic trading in accordance with the disclosed embodiments.

FIG. 2 is a block diagram of an exemplary implementation of a computer device of the system of FIG. 1 for facilitating electronic trading with price band visualization in accordance with the disclosed embodiments.

FIG. 3 depicts a flow chart showing operation of the computer device of FIG. 2.

FIG. 4 shows an illustrative embodiment of a general computer system for use with or in the systems of FIGS. 1 and 2.

FIGS. 5A and 5B show exemplary implementations of electronic trading interfaces of the disclosed embodiments.

### DETAILED DESCRIPTION

The disclosed embodiments relate to an order entry interface used by market participants to enter orders for electronic trading. The order entry interface has a visual indication of a price band imposed upon orders. The visual indication may help market participants know the present location of upper and lower bounds of the price band. Such knowledge may help avoid the entry of fictitious orders by market participants attempting to learn the location of the price band. Such knowledge may also help market participants drive the lower or upper bound of the price band toward the price at which the market participant desires to place an order.

An exchange computer system may impose price banding to validate that orders fall within an acceptable price range. The price range of the price banding may be determined as a fixed amount above and below the price of a last trade. Alternatively, the price banding may be determined as a function of the current market data, e.g., such as the best bid and the best offer. Although described in connection with examples that use algorithms based on the last trade price and/or the current market data, the disclosed embodiments are not limited to a particular algorithm or technique for determining the price band.

An order outside of the price range may be rejected. The rejection may be provided by, or received from, the exchange computer system. Alternatively or additionally, the computer devices and methods of the disclosed embodiments may be configured to provide the rejection. The exchange computer system may thus avoid the burden of receiving and processing unacceptable orders.

The disclosed embodiments may be useful in connection with trading at or near the beginning of a trading session (e.g., a trading day), or at other times when there is no current bid or offer. Market participants may use the visual indication of the price band to avoid having to guess what constitutes a valid price. The visual indication may also be used to avoid receiving a number of rejection messages from the exchange computer system.

The disclosed embodiments may be useful in connection with trading in less liquid markets. The price band is often unduly limiting in less liquid markets due to the absence or scarcity of bids or offers. Market participants are accordingly forced to drive one of the bounds of the price band up or down in less liquid markets in order to place an order. The visual indication of the price band provided by the disclosed embodiments may facilitate such efforts. For example, armed with the knowledge of the price band, a market participant may place an order near one of the bounds of the price band in the interest of moving the bound.

The disclosed embodiments may be useful in decreasing the processing and/or data transmission loads of the exchange computer system. The processing load may decrease with the reduced number of invalid orders submitted by market participants. The exchange computer system may then have a reduced transmission load as a result of a reduced number of rejection messages to send. In some embodiments, further load reductions are achieved by generating and providing the rejection message on the client side, e.g., by the computer device used by the market participant. In such cases, the exchange computer system neither determines whether a proposed order is valid, nor generates a rejection message. The reduced processing load may be significant after aggregation across a large number of markets.

The visual indication of the price band may vary from the examples described below. The visual indication may be a textual, graphical, background, color-based, and/or other element or aspect of the order entry interface. The visual indication may vary, for instance, based on the nature, elements, or other characteristics of the order entry interface. In some cases, the visual indication may include or involve shading of blotter cells of the order entry interface, as described below.

While the disclosed embodiments may be discussed in relation to trading in futures contracts, it will be appreciated that the disclosed embodiments may be applicable to various other financial instruments, such as interest rate swaps or other swaps. The disclosed methods and systems may be used in connection with the trading of a wide variety of financial instruments, such as securities products, e.g., stocks or bonds, and over-the-counter (OTC) derivative products, e.g., interest rate swaps (IRS), credit default swaps (CDS), currency forwards, commodity swaps, equity swaps, etc. The disclosed methods and systems may be applied to many different equity, options, or futures trading systems or other markets now available or later developed. For example, the disclosed methods and systems may be used in the context of various interest rate, currency, and physical commodity markets, such as agricultural markets.

It will be appreciated that brokers, traders, or other entities utilizing the disclosed embodiments, e.g. the market participants, may be referred to by other nomenclature reflecting the role that the particular entity is performing with respect to the disclosed embodiments and that a given entity may perform more than one role depending upon the implementation and the nature of the particular transaction being undertaken, as well as the entity's contractual and/or legal relationship with another market participant and/or the Exchange.

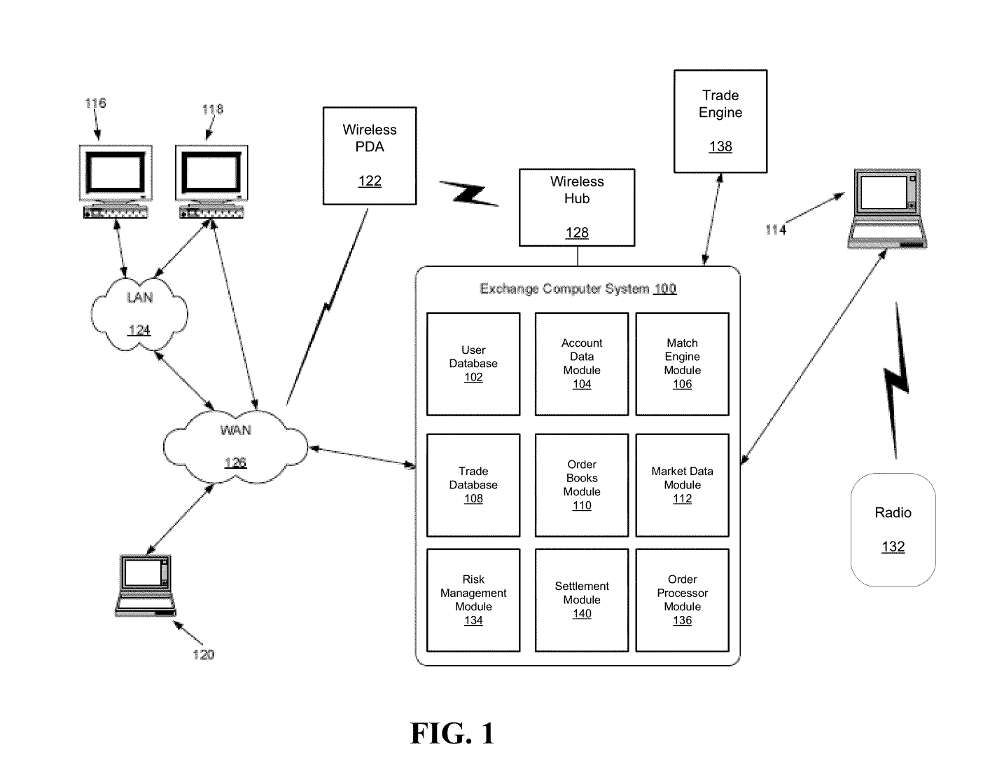

With reference now to the drawing figures, an exemplary trading network environment for implementing trading systems and methods is shown in FIG. 1. An exchange computer system 100 receives orders and transmits market data related to orders and trades to users, such as via wide area network 126 and/or local area network 124 and computer devices 114, 116, 118, 120 and 122, as described below, coupled with the exchange computer system 100.

Herein, the phrase “coupled with” is defined to mean directly connected to or indirectly connected through one or more intermediate components. Such intermediate components may include both hardware and software based components. Further, to clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions hereinbefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

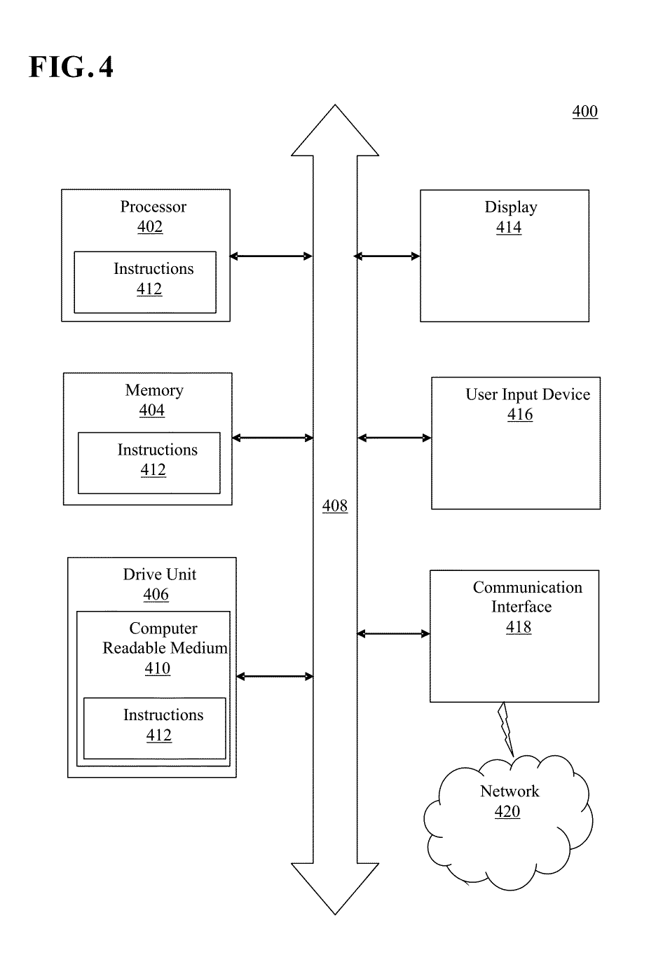

The exchange computer system 100 may be implemented with one or more mainframe, desktop or other computers, such as the computer 400 described below in connection with FIG. 4. A user database 102 may be provided which includes information identifying traders and other users of exchange computer system 100, such as account numbers or identifiers, user names and passwords. An account data module 104 may be provided which may process account information that may be used during trades.

A match engine module 106 may be included to match bid and offer prices and may be implemented with software that executes one or more algorithms for matching bids and offers. The match engine module 106 may be in communication with one or more of the local area network 124, the wide area network 126, or other elements of the exchange computer system 100 to receive data indicative of the orders from the market participants.

A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. The risk management module 134 may also be configured to determine risk assessments or exposure levels in connection with positions held by a market participant. The risk management module 134 may be configured to administer, manage or maintain one or more margining mechanisms implemented by the exchange computer system 100.

An order processing module 136 may be included to decompose delta-based and bulk order types for processing by the order book module 110 and/or the match engine module 106. The order processing module 136 may also be configured to validate incoming orders against price bands. Other modules, such as the match engine module 106, may be used to impose price banding in other embodiments. The order processing module 136 may also be used to implement one or more procedures related to clearing an order. In some cases, the order processing module 136 may communicate with one or more computer devices described below in connection with a reporting obligation for transaction data for the orders.

In the example of FIG. 1, the exchange computer system 100 also includes a settlement module 140 (or settlement processor or other payment processor) to provide one or more functions related to settling or otherwise administering transactions cleared by the Exchange. For example, the settlement module 140 may be configured to communicate with the trade database 108 (or the memory(ies) on which the trade database 108 is stored) and/or to determine a payment amount based on a spot price, the price of the futures contract or other financial instrument, or other price data, at various times.

The exchange computer system 100 may include one or more additional modules or processors, including, for instance, a volume control module configured to, among other things, control the rate of acceptance of mass quote messages. It will be appreciated that concurrent processing limits may be defined by or imposed separately or in combination, as was described above, on one or more of the trading system components, including the user database 102, the account data module 104, the match engine module 106, the trade database 108, the order book module 110, the market data module 112, the risk management module 134, the order processing module 136, or other component of the exchange computer system 100.

The trading network environment shown in FIG. 1 includes exemplary computer devices 114, 116, 118, 120 and 122, which depict different exemplary methods or media by which a computer device may be coupled with the exchange computer system 100 or by which a user may communicate, e.g. send and receive trade or other information therewith. It will be appreciated that the types of computer devices deployed by traders and the methods and media by which they communicate with the exchange computer system 100 is implementation dependent and may vary and that not all of the depicted computer devices and/or means/media of communication may be used and that other computer devices and/or means/media of communications, now available or later developed may be used. Each computer device, which may include a computer 400 described in more detail below with respect to FIG. 4, may include a central processor that controls the overall operation of the computer and a system bus that connects the central processor to one or more conventional components, such as a network card or modem. Each computer device may also include a variety of interface units and drives for reading and writing data or files and communicating with other computer devices and with the exchange computer system 100. Depending on the type of computer device, a user can interact with the computer with a keyboard, pointing device, microphone, pen device, touchpad, touchscreen, or other input device now available or later developed.

An exemplary computer device 114 is shown directly connected to exchange computer system 100, such as via a T1 line, a common local area network (LAN) or other wired and/or wireless medium for connecting computer devices, such as the network 420 shown in FIG. 4 and described below with respect thereto. The exemplary computer device 114 is further shown connected to a radio 132. The user of radio 132, which may include a cellular telephone, smart phone, or other wireless proprietary and/or non-proprietary device, may be a trader or exchange employee. The radio user may transmit orders or other information to the exemplary computer device 114 or a user thereof. The user of the exemplary computer device 114, or the exemplary computer device 114 alone and/or autonomously, may then transmit the trade or other information to the exchange computer system 100.

Exemplary computer devices 116 and 118 are coupled with a local area network (“LAN”) 124 which may be configured in one or more of the well-known LAN topologies, e.g. star, daisy chain, etc., and may use a variety of different protocols, such as Ethernet, TCP/IP, etc. The exemplary computer devices 116 and 118 may communicate with each other and with other computer and other devices which are coupled with the LAN 124. Computer and other devices may be coupled with the LAN 124 via twisted pair wires, coaxial cable, fiber optics or other wired or wireless media. As shown in FIG. 1, an exemplary wireless personal digital assistant device (“PDA”) 122, such as a mobile telephone, tablet based computer device, or other wireless device, may communicate with the LAN 124 and/or the Internet 126 via radio waves, such as via WiFi, Bluetooth and/or a cellular telephone based data communications protocol. PDA 122 may also communicate with exchange computer system 100 via a conventional wireless hub 128.

FIG. 1 also shows the LAN 124 coupled with a wide area network (“WAN”) 126 which may be comprised of one or more public or private wired or wireless networks. In some embodiments, the WAN 126 includes the Internet 126. The LAN 124 may include a router to connect LAN 124 to the Internet 126. Exemplary computer device 120 is shown coupled directly to the Internet 126, such as via a modem, DSL line, satellite dish or any other device for connecting a computer device to the Internet 126 via a service provider therefore as is known. LAN 124 and/or WAN 126 may be the same as the network 420 shown in FIG. 4 and described below with respect thereto.

The users of the exchange computer system 100 may include one or more traders or other market participants, which may maintain a market by providing to the exchange computer system 100 constant bid and offer prices for a financial instrument via one of the computer devices depicted. The exchange computer system 100 may also exchange information with other trade engines, such as trade engine 138. Additional computers and systems may be coupled to the exchange computer system 100. Such computers and systems may include clearing, regulatory, and fee systems.

The operations of computer devices and systems shown in FIG. 1 may be controlled by computer-executable instructions stored on a non-transitory computer-readable storage medium. For example, the exemplary computer device 116 may include computer-executable instructions for receiving order information from a user and transmitting that order information to exchange computer system 100. In another example, the exemplary computer device 118 may include computer-executable instructions for receiving market data from exchange computer system 100 and displaying that information to a user.

Numerous additional servers, computers, handheld devices, personal digital assistants, telephones and other devices may also be connected to the exchange computer system 100. Moreover, the topology shown in FIG. 1 is merely an example and that the components shown in FIG. 1 may include other components not shown and be connected by numerous alternative topologies.

An order for a transaction involving one or more financial instruments may be facilitated through a number of interfaces generated at the computer devices 114, 116, 118, 120. Each interface may be presented via a display of the computer devices. In some cases, one or more interfaces are generated via a client-server framework. A component of the exchange computer system 100 may act as a server for one or more of the computer devices 114, 116, 118, 120 acting as a client. For example, the order processor module 136 and/or the order books module 110 may provide services and logic to support the entry, processing, and other handling of orders. A service provided by the order processor module 136 may include the generation of one or more interfaces to support the entry of order data (e.g., financial instrument type, quantity, price, time, etc.). The interface(s) may include a trade entry form or other order entry interface. A service of the order books module 110 may include the generation of one or more interfaces to support the display of trade book data to a user. These services may be provided via client-side applications executed on one of the computer devices 114, 116, 118, 120. Such applications may access data, logic, and/or instructions on a server (e.g., server module) of the exchange computer system 100 to provide the interfaces. Alternatively or additionally, the services may be implemented via a client-side browser responsive to data, logic, and/or instructions provided by the server. The location of the logic, instructions, and data for implementing the services may vary. For example, some or all of the instructions, logic, and/or data to generate the interfaces may be resident on one of the computer devices 114, 116, 118, 120.

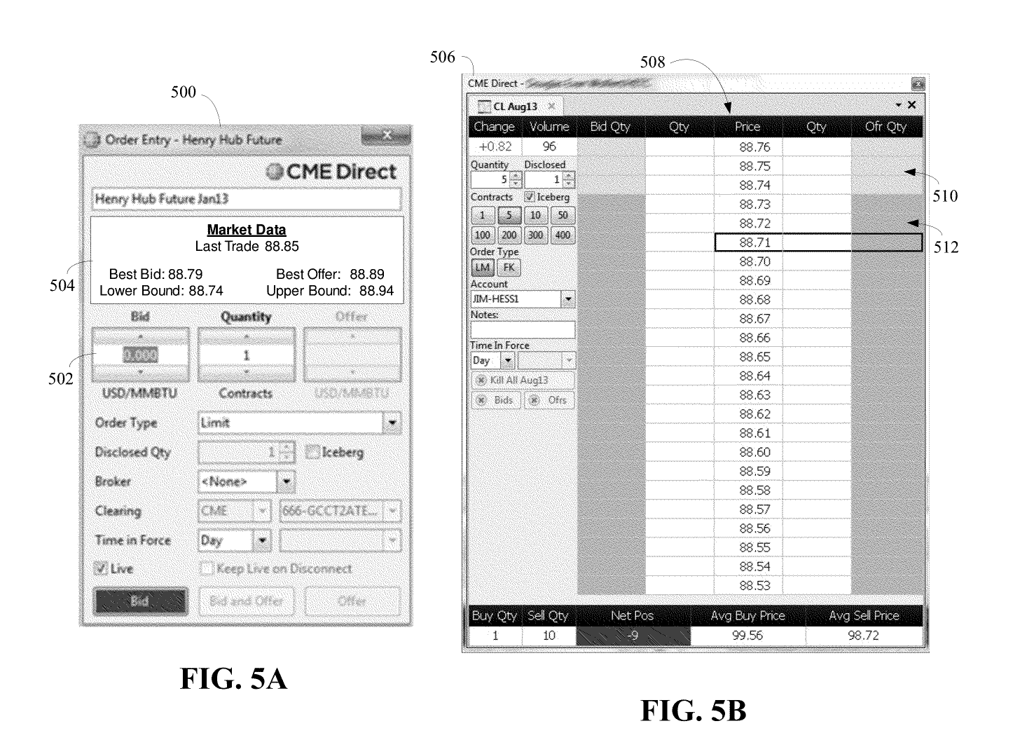

Multiple and/or alternative order entry interfaces may be generated. Each interface is generated at one of the computer devices 114, 116, 118, 120 for a particular broker, trader, or other market participant involved in the transaction. Each order entry interface is configured for entry of data indicative of an order for a trade of a financial instrument. The data may specify the type of financial product, quantity, price, and/or other transaction data. Examples of order entry interfaces are shown in FIGS. 5A and 5B and described below. One or both of the interfaces may be integrated or generated in connection with an electronic trading system or platform, such as CME Globex and/or CME Direct for the Chicago Mercantile Exchange (CME Group, Inc.).

The order entry interfaces may be integrated to any desired extent. In some cases, the interfaces may be accessible from one another or be otherwise linked to one another. For example, an order entry form may be launched by selecting an option made available in another order entry interface. Alternative or additional order entry interfaces may be generated.

The computer devices 114, 116, 118, 120 may communicate with a number of the above-referenced modules of the exchange computer system 100 in generating the order entry interface(s). In some embodiments, the match engine module 106, the trade database 108, the order books module 110, the market data module 112, and/or the order processor module 136, may be accessed to obtain and/or store market data, transaction data, and/or other data used in a price banding or other determination. For example, price, quantity, and other transaction data may be stored in, and provided by, the trade database 108 for past transactions. Data indicative of the current market, such as the best bid and best offer, may be stored in, and provided by, the order books module 110 and/or the market data module 112. In some cases, the order processor module 136 may support the generation of the order entry interface(s) and/or otherwise support transmission of transaction, market, and/or other data between the computer device 114, 116, 118, 120 and the exchange computer system 100.

It will be appreciated the disclosed embodiments may be implemented by or in connection with a different or separate module of the exchange computer system 100 (or a separate computer system coupled with the exchange computer system 100) other than those shown in FIG. 1 and/or described above. For example, the disclosed embodiments may be implemented by or in connection with a module of the exchange computer system dedicated to order validation, such as a price banding module.

As described herein, the disclosed embodiments may be implemented as a centrally accessible system or as a distributed system. For instance, one or more aspects of the disclosed embodiments may be implemented by one of the computer devices 114, 116, 118, 120. The implementation of such aspects may be separate from, or integrated with, the operation of the modules of the exchange computer system 100 to any desired extent. Distributed processing may reduce processing demands presented by the management of transactions, such as block trades. Addressing the validation or orders solely at the exchange computer system 100 may drain processing time and resources from other exchange functions. For example, the processing demands presented by the entry of invalid orders may be reduced as a result of the visualization of price band information at one of the computer devices 114, 116, 118, 120. If price-based order validation is implemented, for instance, at one of the computer devices 114, 116, 118, 120, the processing capacity of the exchange computer system 100 is not consumed by tasks related to order validation, such as rejection messaging.

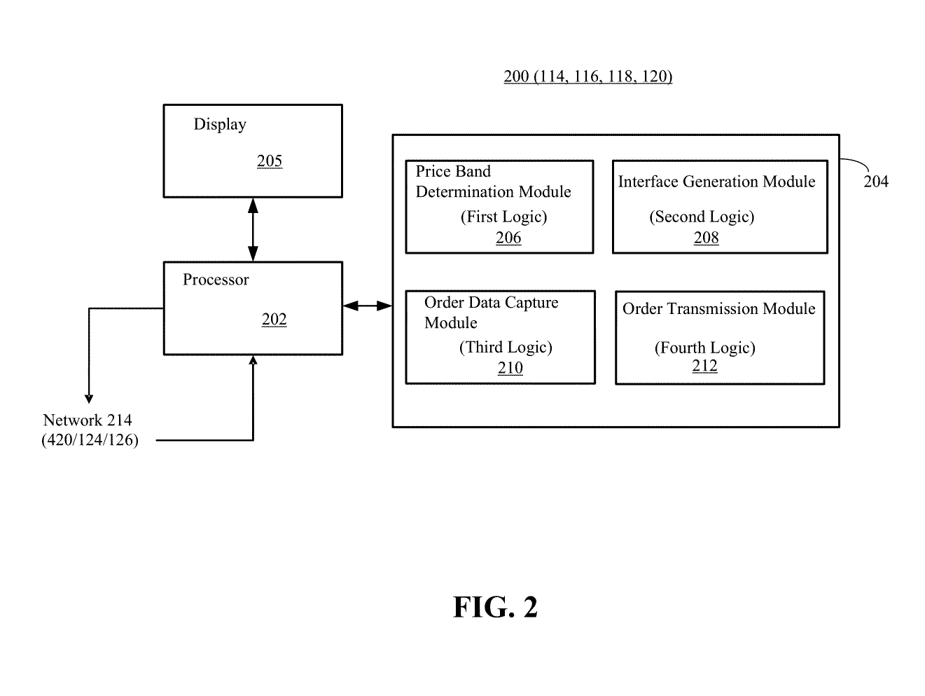

As described below in connection with the exemplary embodiments of FIGS. 2, 3, and 5A and 5B, one or more of the module(s) of the exchange computer system 100 and/or one of the computer devices 114, 116, 118, 120 may be configured to facilitate an order by a market participant for a trade of a financial instrument via the exchange computer system 100 (e.g., via one or more of the above-described modules of the exchange computer system 100). The order may be facilitated through a visual indication of price banding applicable to the order. The visual indication is incorporated into an order entry interface generated by one of the computer devices 114, 116, 118, 120. The visualization of the price banding may be useful in helping market participants place valid orders for trades and/or in helping market participants adjust a bound of the price banding (i.e., walking the price band).

To facilitate the order placement, the module(s) of the exchange computer system 100 and/or the computer device(s) 114, 116, 118, 120 are configured via, e.g., respective computer-readable instruction sets, as described below to cause the computer device to perform operations including, for instance, (1) determining a price band established by the exchange computer system to dictate whether the order is a valid order of the financial instrument, (2) generating an order entry interface, the order entry interface being configured for entry of data by the market participant indicative of the order of the financial instrument, the order entry interface including a visual indication of the price band, (3) capturing data indicative of the order entered via the order entry interface, and (4) transmitting the captured data to the exchange computer system if the order falls within the price band. As described below, fewer, alternative, or additional operations may be performed. The computer-readable instruction sets may be configured to support a client-server arrangement for performing the operations, in which one or more modules of the exchange computer system 100 act as the server and the computer device 114, 116, 118, 120 acts as the client. Alternatively or additionally, the computer-readable instruction sets may be configured to support execution of the operations solely at the client side.

FIG. 2 depicts a block diagram of a computer system 200 for entry of an order for a financial instrument trade with price band visualization. The computer system 200 may correspond with, or include, one of the computer devices 114, 116, 118, 120. The computer system 200 may alternatively correspond with, or additionally include, one or more of the above-described modules of the exchange computer system 100, such as the order books module 110 and/or the order processor module 136. An Exchange supports the receipt, administration, management, and/or other processing of orders from market participants for transactions of financial instruments. The computer system 200 of FIG. 2 is configured to facilitate such orders by providing the market participants with an indication of the price banding imposed by the Exchange. As described below, price banding information is provided via an order entry interface generated by the computer system 200.

The computer system 200 includes a processor 202, a memory 204, and a display 205. The memory 204 and the display 205 are coupled with the processor 202. The processor 202, the memory 204, and the display 205 may be implemented as a processor 402, a memory 404, and a display 414, respectively, as described below with respect to FIG. 4. The computer system 200 further includes a number of logic units. In this embodiment, the computer system 200 includes four logic units directed to implementing the order entry and price band visualization techniques of the disclosed embodiments. Each logic unit may be implemented as a discrete software module. Each module may include or correspond with a component of an instruction set resident on one of the computer devices 114, 116, 118, 120. Alternatively, the logic unit may be implemented via an instruction set executed via a browser of one of the computer devices 114, 116, 118, 120. The instruction set may be provided to the browser via a client-server relationship. In some cases, the exchange computer system 100 of FIG. 1 may provide the server functionality of the relationship. The modules and/or instruction sets may be integrated to any desired extent. Additional modules may be provided. For example, separate modules may be provided for validating orders and rejecting invalid orders.

In the embodiment of FIG. 2, the computer system 200 includes first logic 206 stored in the memory 204 and executable by the processor 202 to cause the processor 202 to determine a price band established by the exchange computer system to dictate whether the order is a valid order of the financial instrument. In some cases, the price band is determined via computations implemented by the computer system 200. For instance, the first logic 206 may be further executable by the processor 202 to cause the processor 202 to receive market data for the financial instrument from the exchange computer system 100 (FIG. 1), and compute an upper bound and a lower bound of the price band as a function of the market data. The market data may include the latest trade data and/or the best current offer and/or bid. The market data may be provided by the trade database 108, the order book module 110, and/or the market data module 112. Further details regarding exemplary techniques for computing the bounds of the price band as a function of such market data are provided below.

Alternatively or additionally, the first logic 206 determines the price band by obtaining price band data from the exchange computer system 100. The first logic 206 may be further executable by the processor 202 to cause the processor 202 to receive an upper bound and a lower bound for the price band from the exchange computer system 100. The upper and lower bound may, for instance, be computed by the order processor module 136, the order books module 110, and/or one of the other modules depicted in FIG. 1. In some embodiments, the first logic 206 may rely on the exchange computer system 100 to compute the price band in certain circumstances (or certain time periods), and then compute (e.g., update) the price band in other circumstances.

The computer system 200 further includes second logic 208 stored in the memory 204 and executable by the processor 202 to cause the processor 202 to generate an order entry interface via the display 205. The order entry interface includes a visual indication of the price band. The price band may be incorporated into the order entry interface in one or more ways. The price band may be indicated textually (e.g., “Lower Bound=312.5; Upper Bound=363.5”), graphically (e.g., via symbols adjacent to, or separating, valid and invalid prices), or via other visual elements of the order entry interface (e.g., a background color or shading).

The order entry interface is configured for entry of data by the market participant indicative of the order of the financial instrument. The order entry interface may be configured as an order entry ticket interface, an example of which is shown in FIG. 5A. Alternatively or additionally, the order entry interface is configured as a vertical price grid, an example of which is shown in FIG. 5B. The second logic 208 may thus be further executable by the processor 202 to cause the processor 202 to render a vertical price grid via the display 205, the vertical price grid having a list of prices for the financial instrument. Each price may be a selectable interface element. The visual indication of the price band may then be integrated into the vertical price grid. In some cases, the visual indication is a background color of the vertical price grid. For example, the vertical price grid may include a blotter or table with a number of cells adjacent the list of prices for entry of order quantities and/or other order data. The blotter may be color-coded to provide the visual indication of the price grid. For example, certain cells may have a background color indicative of a valid price. Cells associated with invalid prices may be shaded with a different color.

The price band may be computed based on the last price at which the financial instrument traded. For example, upper and lower bounds of the price band may be computed as a predetermined number of points, or ticks (the smallest price denomination recognized by the Exchange for the financial instrument), above and below the last trade price. The price band may be computed based on the current market conditions, e.g., the best offer and the best bid. The upper and lower bounds may then be computed as a predetermined number of points, or ticks, above and below the best offer and best bid, respectively. Other computational algorithms may be used, including, for example, a relative calculation (e.g., +/−10% of the last trade price or best bid/offer). The disclosed embodiments may also use computational algorithms or techniques used or developed in the future. Combinations of the computational techniques may be used in certain circumstances. For example, both techniques may be used when the market conditions do not include a last trade, a bid, or an offer. The manner in which the price band is computed may vary considerably. The upper and lower bounds may be computed differently.

The computer system 200 further includes third logic 210 stored in the memory 204 and executable by the processor 202 to cause the processor 202 to capture data indicative of the order entered via the order entry interface. The data may be entered via various user interface devices or elements, examples of which are provided below in connection with FIG. 4. The data may include a price, quantity, and/or other order data. In some cases, some or all of the data is inferred or indirectly determined via interaction with the computing system 200. For example, a market participant may select a cell or other user interface element to establish the price, rather than providing a numerical entry. The manner in which the order data is entered and captured may vary considerably from the examples shown.

The computer system 200 further includes fourth logic 212 stored in the memory 204 and executable by the processor 202 to cause the processor 202 to transmit the order data to the exchange computer system 100 (FIG. 1). In some cases, the order data is transmitted to the exchange computer system 100 for validation by the exchange computer system 100. The computer system 200 may thus not analyze the order data to determine whether the order falls within the price band.

In other cases, the transmission of the order data is conditioned upon validation in accordance with the price band. The fourth logic 212 may be further executable by the processor 202 to cause the processor 202 to reject the order data if the order falls outside of the price band. An analysis of the order data may thus occur before the order data is transmitted via, e.g., the network 214 or network 420, for processing by the exchange computer system 100 (FIG. 1). If the order data falls within the price band, then the processor 202 may send the order data to the exchange computer system 100 via one or more of communication links of the network 214, such as the LAN 124 and/or the WAN 126.

The analysis of the order data by the computer system 200 may reduce the processing load of the exchange computer system 100 (FIG. 1). The burden of order validation may thus be distributed over the network 214. Such distributed processing may help the exchange computer system 100 respond more quickly to valid orders. A quicker response time may be useful, for instance, in situations in which a market participant is attempting to adjust the price band through repeated bids or offers.

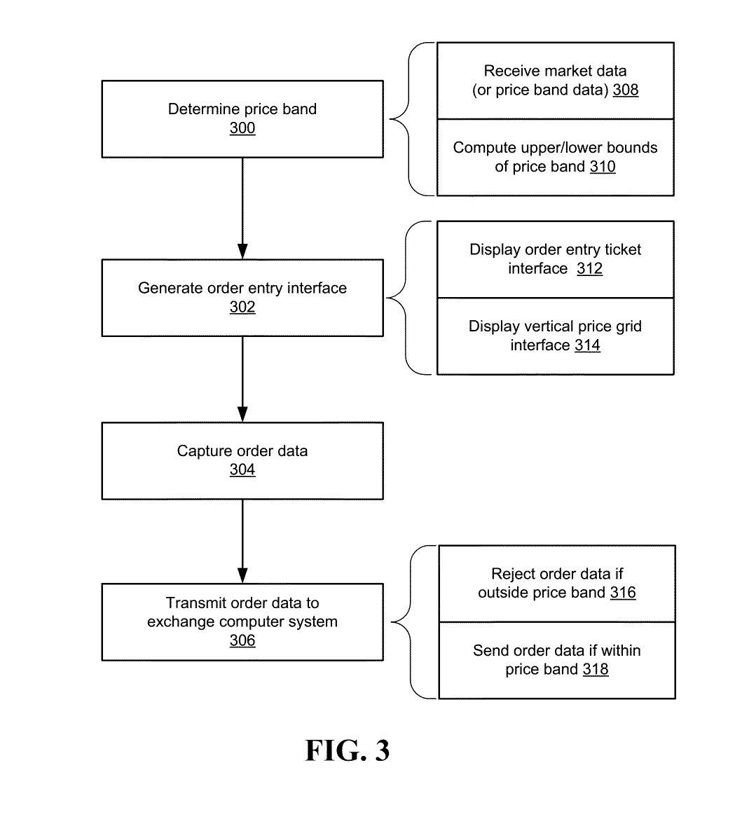

FIG. 3 depicts a flow chart showing operation of the computer system 200 of FIG. 2. In particular, FIG. 3 shows a computer-implemented method of facilitating an order by a market participant for a trade of a financial instrument. The method may manage or otherwise facilitate orders by providing a visual indication of a price band imposed on the order. The operation of the system 200 includes: determining a price band for valid orders of the financial instrument [block 300]; generating an order entry interface configured for entry of data by the market participant indicative of the order of the financial instrument, the order entry interface including a visual indication of the price band [block 302]; capturing data indicative of the order entered via the order entry interface [block 304]; and, transmitting the captured data to the exchange computer system [block 306].

In some embodiments, the determination of the price band includes receiving market data for the financial instrument from the exchange computer system [block 308] and computing an upper bound and a lower bound of the price band as a function of the market data. The upper and lower bounds may be computed as described above. Alternatively or additionally, the price band determination includes obtaining or receiving an upper bound and a lower bound for the price band from the exchange computer system.

The order entry interface may be configured as an order entry ticket interface. Generating the order entry interface may thus include displaying the order entry ticket interface [block 312]. The order entry ticket interface may include a scroll wheel, text box, or other interface element configured to allow the market participant to specify a price. The order entry ticket interface may include a display panel in which the price band is set forth. The upper and lower bounds of the price band may then be identified in the display panel. For example, the upper and lower bounds may be identified along with other market information, such as the best offer and the best bid currently on the market. An example of this configuration of the order entry ticket interface is shown in FIG. 5A.

The order entry interface may be configured as a vertical price grid. Generating the order entry interface may thus include displaying the vertical price grid interface [block 314]. The vertical price grid interface comprising a list of prices for the financial instrument. Each price may be provided as a selectable interface element, such as table cell or other blotter element.

The visual indication of the price band may be integrated into the vertical price grid in various ways. In some cases, the prices are listed with graphical elements, such as a line or other symbol, demarcating the bounds of the price band. Alternatively or additionally, a background color of the blotter area or other list of prices is varied to indicate which prices fall within, or outside of, the price band. An example of this configuration of the vertical price grid is shown in FIG. 5B.

The visual indication of the price band may be presented in other ways than the examples shown in FIGS. 5A and 5B. The visual indication may be disposed adjacent to the list of prices or other user interface elements without a dedicated panel or the use of a background color. For example, the visual indication may alternatively be configured in accordance with other formats, positions, layouts, and other user interface characteristics. A variety of different user interface elements, layouts, and other features may be used to visually indicate to the user the upper and lower bounds, including features developed or used in the future.

In some embodiments, transmitting the captured data includes rejecting the captured data if the order falls outside of the price band [block 316]. The captured data may then be sent to the exchange computer system if the order falls within the price band [block 318]. The order data may be validated to determine whether the order data is transmitted to the exchange computer system. In other embodiments, the order data is not analyzed or validated before transmission.

The blocks of the above-described method may be implemented in an order other than as shown. For example, a portion of the order entry interface may be generated or rendered before the price band is obtained or otherwise determined. The order entry interface may be generated concurrently with the price band determination. Additional, fewer, or alternative blocks may be implemented. For example, the method may include one or more blocks directed to generating (and/or receiving) error or other messages relating to, for instance, an order being deemed invalid for falling outside of the price band.

One or more modules described herein may be implemented using, among other things, a tangible computer-readable storage medium comprising computer-executable instructions (e.g., executable software code). Alternatively, modules may be implemented as software code, firmware code, hardware, and/or a combination of the aforementioned. For example the modules may be embodied as part of an exchange system 100 for financial instruments.

Referring to FIG. 4, an illustrative embodiment of a general computer system 400 is shown. The computer system 400 can include a set of instructions that can be executed to cause the computer system 400 to perform any one or more of the methods or computer-based functions disclosed herein. The computer system 400 may operate as a standalone device or may be connected, e.g., using a network, to other computer systems or peripheral devices. Any of the components discussed above, such as the processor 202, may be a computer system 400 or a component in the computer system 400. The computer system 400 may implement a match engine, order processing, margining, and/or other function on behalf of an Exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In a particular embodiment, as depicted in FIG. 4, the computer system 400 may also include a disk or optical drive unit 406. The disk drive unit 406 may include a computer-readable storage medium 410 in which one or more sets of instructions 412, e.g. software, can be embedded. Further, the instructions 412 may embody one or more of the methods or logic as described herein. In a particular embodiment, the instructions 412 may reside completely, or at least partially, within the memory 404 and/or within the processor 402 during execution by the computer system 400. The memory 404 and the processor 402 also may include computer-readable media as discussed above.

The present disclosure contemplates a computer-readable storage medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. While the computer-readable storage medium is shown to be a single medium, the term “computer-readable storage medium” includes a single medium or multiple media, such as a centralized or distributed database, and/or associated caches and servers that store one or more sets of instructions. The term “computer-readable storage medium” shall also include any medium that is capable of storing, encoding or carrying a set of instructions for execution by a processor or that cause a computer system to perform any one or more of the methods or operations disclosed herein. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

In a particular non-limiting, exemplary embodiment, the computer-readable storage medium can include a solid-state memory such as a memory card or other package that houses one or more non-volatile read-only memories. Further, the computer-readable storage medium can be a random access memory or other volatile re-writable memory. Additionally, the computer-readable storage medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable storage medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, macroinstruction or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and anyone or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

FIG. 5A provides an exemplary implementation of an order entry interface 500 with price band visualization in accordance with one embodiment. As described above, one or more aspects of the order entry interface 500 may be directed to facilitating orders via the visualization of price band information. In this embodiment, the order entry interface 500 is configured as an order entry ticket. The order entry ticket 500 has a set of user interface elements 502 for specifying a bid (or offer) price and a quantity. The price and quantity data may be entered via a keyboard into text boxes of the interface elements and/or via increment/decrement buttons. A variety of other data entry methods and techniques may be used. For example, price and/or quantity data may be auto-populated or automatically provided through selection (e.g., double-clicking) on a grid of the order entry interface 500. In this example, a lower bound (88.74) and an upper bound (88.94) of the price band is displayed in a panel 504 adjacent the user interface elements for entering the order data. The price band is indicated along with market data in the panel 504. In this example, the market data includes the price of the last executed trade (88.85), the best current bid (88.79), and the best current offer (88.89). Additional, fewer, or alternative market data items may be displayed. In this example, the panel 504 with the price band visualization is disposed adjacent a panel that identifies the financial instrument to which the order is directed (i.e., Henry Hub futures). The position of the panel 504 in the order entry interface may vary from the example shown. The extent to which data is presented with the price band information may also vary.

FIG. 5B provides an exemplary implementation of a vertical price grid 506 with price band visualization in accordance with one embodiment. The price band is indicated non-textually in this embodiment. The vertical price grid 506 includes an order blotter or table 508 having columns for entering bid or offer quantities for an order. Each cell in the columns may be selected by the market participant to initiate an order. In FIG. 5B, the cells associated with the price 88.71 are shown after such selection. In this embodiment, the indication of the price band is integrated into the vertical price grid 506 through a background color of respective areas of the order blotter. The background color of the cells (e.g., in an area 510) within the price band have a lighter (e.g., light blue) background color than those cells (e.g., in an area 512) associated with prices falling outside of the price band. In this example, the prices outside of the price band are shaded with a darker background color (e.g., gray). The lower bound of the price band is thus 88.74 in this example. In other vertical price grid embodiments, the price band may be indicated via borders or other lines, or other graphical or non-graphical elements.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method of facilitating an order by a market participant for a trade of a financial instrument via an exchange computer system, the method comprising:
determining a price band for valid orders of the financial instrument;
generating, with a processor, an order entry interface configured for entry of data by the market participant indicative of the order of the financial instrument, the order entry interface comprising a visual indication of the price band;
capturing data indicative of the order entered via the order entry interface; and
transmitting the captured data to the exchange computer system.

2. The computer-implemented method of claim 1 wherein determining the price banding values comprises:
receiving market data for the financial instrument from the exchange computer system; and
computing an upper bound and a lower bound of the price band as a function of the market data.

3. The computer-implemented method of claim 1 wherein determining the price banding values comprises receiving an upper bound and a lower bound for the price band from the exchange computer system.

4. The computer-implemented method of claim 1 wherein the order entry interface is configured as an order entry ticket interface.

5. The computer-implemented method of claim 1 wherein the order entry ticket interface comprises a display panel with the visual indication of the price band, the display panel identifying an upper bound and a lower bound for the price band.

6. The computer-implemented method of claim 1 wherein the order entry interface is configured as a vertical price grid interface.

7. The computer-implemented method of claim 1 wherein generating the order entry interface comprises displaying a vertical price grid interface, the vertical price grid interface comprising a list of prices for the financial instrument, each price being a selectable interface element, the visual indication of the price band being integrated into the vertical price grid.

8. The computer-implemented method of claim 7 wherein the visual indication is disposed adjacent to the set of prices.

9. The computer-implemented method of claim 7 wherein the visual indication comprises a background color of the vertical price grid.

10. The computer-implemented method of claim 1 wherein transmitting the captured data comprises:
rejecting the captured data if the order falls outside of the price band; and
sending the captured data to the exchange computer system if the order falls within the price band.

11. A system to facilitate an order by a market participant for a trade of a financial instrument via an exchange computer system, the system comprising a processor, a memory coupled with the processor, and a display coupled with the processor, the system further comprising:
first logic stored in the memory and executable by the processor to determine a price band established by the exchange computer system to dictate whether the order is a valid order of the financial instrument;
second logic stored in the memory and executable by the processor to generate an order entry interface via the display, the order entry interface being configured for entry of data by the market participant indicative of the order of the financial instrument, the order entry interface comprising a visual indication of the price band;
third logic stored in the memory and executable by the processor to capture data indicative of the order entered via the order entry interface; and
fourth logic stored in the memory and executable by the processor to transmit the captured data to the exchange computer system.

12. The system of claim 11 wherein the first logic is further executable by the processor to cause the processor to receive market data for the financial instrument from the exchange computer system, and compute an upper bound and a lower bound of the price band as a function of the market data.

13. The system of claim 11 wherein the first logic is further executable by the processor to cause the processor to receive an upper bound and a lower bound for the price band from the exchange computer system.

14. The system of claim 11 wherein the order entry interface is configured as an order entry ticket interface.

15. The system of claim 11 wherein the second logic is further executable by the processor to cause the processor to render a vertical price grid via the display, the vertical price grid comprising a list of prices for the financial instrument, each price being a selectable interface element, the visual indication of the price band being integrated into the vertical price grid.

16. The system of claim 15 wherein the visual indication comprises a background color of the vertical price grid.

17. The system of claim 11 wherein the fourth logic is further executable by the processor to cause the processor to reject the captured data if the order falls outside of the price band, and send the captured data to the exchange computer system if the order falls within the price band.

18. A computer program product to facilitate an order by a market participant for a trade of a financial instrument via an exchange computer system, the computer program product comprising one or more computer-readable storage media having stored thereon computer-executable instructions for execution by one or more processors of a computing system to cause the computing system to perform operations, the operations comprising:
determining a price band established by the exchange computer system to dictate whether the order is a valid order of the financial instrument;
generating an order entry interface, the order entry interface being configured for entry of data by the market participant indicative of the order of the financial instrument, the order entry interface comprising a visual indication of the price band;
capturing data indicative of the order entered via the order entry interface; and
transmitting the captured data to the exchange computer system if the order falls within the price band.

19. The computer program product of claim 18, the operations further comprising:
receiving market data for the financial instrument from the exchange computer system; and
computing an upper bound and a lower bound of the price band as a function of the market data.

20. The computer program product of claim 18 wherein generating the order entry interface comprises displaying a vertical price grid, the vertical price grid comprising a list of prices for the financial instrument, each price being a selectable interface element, the visual indication of the price band being integrated into the vertical price grid.
